(19) United States
(12) Patent Application Publication
(10) Pub. No.: US 2026/0236738 A1
(43) Pub. Date: Aug. 13, 2026

(54) GRAPH NEURAL NETWORKS TO IMPROVE GROUND-BASED MONITORING

(71) Applicant: X DEVELOPMENT LLC, Mountain View, CA (US)

(72) Inventors: Artem GONCHARUK, Mountain View, CA (US); Jaewoo KIM, Houston, TX (US); Robert CLAPP, Sunnyvale, CA (US); Stuart FARRIS, Palo Alto, CA (US)

(21) Appl. No.: 19/633,541

(22) Filed: Mar. 30, 2026

Related U.S. Application Data
(63) Continuation of application No. PCT/US2025/061604, filed on Dec. 30, 2025.
(60) Provisional application No. 63/740,733, filed on Dec. 31, 2024.

(51) Int. Cl. G06N 3/042; G01V 1/30; G06N 3/08

(52) U.S. Cl. CPC G06N 3/042; G01V 1/303; G06N 3/08

(57) ABSTRACT

Disclosed herein are systems and methods for training a neural network generating seismic training data comprising at least three sets of training data: a first set that comprises training data that represents a simulated seismic event, and at least two second sets, each second set comprising training data of sensor values, each second set of sensor values corresponding to distinct simulated seismic observation systems, and each seismic value of each second set comprises an associated arrival time value; introducing a time offset to each arrival time value of each second set of seismic values to generate modified seismic training data; generating a plurality of graphs, each graph based on one set of training data from the first set of training data and the at least two sets of sensor values; and training the neural network using the plurality of graphs as input.

### CROSS-REFERENCE TO RELATED APPLICATION

This application is a continuation of International Application No. PCT/US2025/061604, filed December 30, 2025, which claims priority under 35 USC §119(e) to U.S. Patent Provisional Application Serial No. 63/740,733, filed on December 31, 2024, the entire contents of which are hereby incorporated by reference.

### FIELD OF THE DISCLOSURE

The disclosure relates to fiber optic monitoring and more specifically, to ground-based fiber optic monitoring using distributed fiber optic sensing.

### BACKGROUND

Subsurface exploration and monitoring is a costly and time-intensive task. Current methods for subsurface exploration involve manned expeditions traveling across an exploitation zone with localized sensing equipment. The acoustic, gravity, electromagnetic, electric, and/or geomagnetic sensors employed are expensive, sensitive, and acquire information in geographically localized areas (e.g., > 1 sqkm). The tools generate sparse data, being highly localized and not substantially penetrative when compared to the overall areas of geological exploration.

The task-specific tools currently used for such exploration and monitoring require a high degree of human engagement and training and frequently lack integration, thereby limiting repeatability and scalability. These tools can also demand substantial computational resources and result in prolonged site assessment periods before a final exploitation or ongoing monitoring phase can begin. The traditional processes are not suitable for scalability without significant investment in additional tools, person-hours, and training.

The lack of substantial and interconnected databank and scalable computational resources limit subsurface exploration and monitoring. Once the zone is grossly mapped and the area demarked, characterization of the subsurface resources involves additional expensive and time-consuming data collection with increasingly complex tools. These current exploration and monitoring capabilities are insufficient to meet the needs of the modern industry. Thus, innovation is needed in remote sensing, data ingestion, machine learning, and physics modeling.

Distributed fiber optic sensing (DFOS) devices can detect subsurface acoustic events (e.g., acoustic, seismic, vibrational disturbances, temperature, or stress/strain) along the length of a fiber-optic cable. Changes in the fiber optic cable can be caused by acoustic vibrations in the surrounding environment (e.g., but not limited to, seismic waves, ground motion, or movement of people or vehicles). By analyzing backscattered laser pulses, DFOS devices measure the amplitude, frequency, and direction of signals interacting with the fiber optic cable at different locations, including, for example, the severity, location, type, and/or direction of travel of the acoustic event(s).

### SUMMARY

In general, an aspect disclosed herein is a computer-implemented method of training a neural network. The computer - implemented method includes generating seismic training data comprising at least three sets of training data: a first set that may include training data that represents a simulated seismic event, and at least two second sets, each second set may include training data of sensor values, each second set of sensor values corresponding to distinct simulated seismic observation systems, and each seismic value of each second set may include an associated arrival time value; introducing a time offset to each arrival time value of each second set of seismic values to generate modified seismic training data; generating a plurality of graphs, each graph based on one set of training data from the first set of training data and the at least two sets of sensor values; and training the neural network using the plurality of graphs as input such that the trained neural network generates a time value correction for each arrival time value.

Examples may include one or more of the following features. The trained neural network may generate a time value correction for each arrival time value. The time offset may be a random time offset. The random time offset may be generated according to a random distribution. The set of seismic values may include arrival time values, signal peak time values, signal peak amplitude values, primary (p) wave amplitude values, p wave envelope values, p wave arrival time values, secondary (s) wave amplitude values, s wave envelope values, or s wave arrival time values.

The distinct seismic collection systems may include a distributed fiber optic sensing (DFOS) system, ocean bottom sensor network, an array of seismometers, a geophone network, or a combination thereof. The neural network may be a graph neural network (GNN). The simulated seismic event may be an earthquake, a leak event or a water hammer event in a municipal water distribution network, or a leak event in a carbon sequestration site.

In general, an aspect disclosed herein is non-transitory, computer readable storage medium storing instructions that, when executed by at least one processor, cause the at least one processor to perform operations including generating seismic training data may include at least three sets of training data: a first set representing a simulated seismic event, and at least two sets of sensor values, where each set of sensor values corresponding to distinct simulated seismic observation systems, and each seismic value of every set having an associated arrival time value; introducing a time offset to each arrival time value of each set of seismic values to generate modified seismic training data; generating a plurality of graphs, each graph based on one set of training data from the first set of training data and the at least two sets of sensor values; and training the neural network using plurality of graphs as input such that the trained neural network generates a time value correction for each arrival time value.

In general, an aspect disclosed herein is a system for monitoring seismic events including a network of seismic receivers; at least one processor; and a non-transitory, computer readable storage medium storing instructions that, when executed by at least one processor, cause the at least one processor to perform operations, including: generating seismic training data may include at least three sets of training data: a first set representing a simulated seismic event, and at least two sets of sensor values, where each set of sensor values corresponding to distinct simulated seismic observation systems, and each seismic value of every set having an associated arrival time value; introducing a time offset to each arrival time value of each set of seismic values to generate modified seismic training data; generating a plurality of graphs, each graph based on one set of training data from the first set of training data and the at least two sets of sensor values; and training the neural network using plurality of graphs as input such that the trained neural network generates a time value correction for each arrival time value.

Examples may include one or more of the following features.

The network of seismic receivers may include a DFOS system, a seismograph array, or both.

In general, an aspect disclosed herein is a computer-implemented method of training a neural network, the method executed by one or more processors and including: generating, by the one or more processors, seismic training data including: a first set of training data representing a simulated seismic event, a second set of training data, and a third set of training data, wherein the second set of training data and the third set of training data each represent a distinct set of sensor values corresponding to distinct simulated seismic observation systems, and each distinct sensor value of the second set of training data and the third set of training data includes an associated arrival time value; introducing, by the one or more processors, a time offset to each arrival time value of the second set of training data and the third set of training data to generate a first set of modified training data and a second set of modified training data; generating, by the one or more processors and using the first set of modified training data and a second set of modified training data, a plurality of graphs, each graph of the plurality of graphs based on at least one of the first set of training data, the first set of modified training data, or the second set of modified training data; and training, using the plurality of graphs as input, the neural network such that the trained neural network generates a time value correction for each arrival time value of the first set of modified training data and the second set of modified training data.

The examples disclosed herein can include one or more of the following features.

The method can include generating the time offset using a time offset generation function. Generating the time offset can use the offset generation function can include generating the time offset for the second set of training data using a first offset generation function and generating the time offset for the third set of training using a second offset generation function that is different than the first offset generation function.

The time offset generation function can be a random time offset generation function. The time offset generation function can be a time offset correlation function which represents a correlation between at least two variables of the second set of training data, the third set of training data, or both. The set of seismic values can include arrival time values, signal peak time values, signal peak amplitude values, primary (P) wave amplitude values, P wave envelope values, P wave arrival time values, secondary (S) wave amplitude values, S wave envelope values, S wave arrival time values, a simulated magnitude, a simulated epicenter location, a simulated focal depth, a simulated fault orientation, a simulated rupture velocity, a simulated slip distribution, a simulated seismic moment, a simulated peak ground acceleration (PGA) value, a simulated peak ground velocity (PGV) value, source mechanism, a simulated peak ground displacement (PGD) value, a water leak size, or a water leak velocity. The distinct seismic collection systems can include a distributed acoustic sensing (DAS) system, distributed strain sensing (DSS) system, an ocean bottom sensor network, an array of seismometers, a geophone network, an accelerometer network, or a combination thereof. The neural network can be a graph neural network (GNN). The simulated seismic event can be an earthquake, a water hammer event in a municipal water distribution network, or a leak event in a carbon sequestration site. The simulated seismic event can be a nature-related simulated seismic event including data representing animal noise. The method can include generating, by the one or more processors and using the modified seismic training data, a probability map including probability values for the time offset for each arrival time value of the second set of training data, the third set of training data, or both, and generating, by the one or more processors and using the modified seismic training data, a plurality of graphs includes generating, by the one or more processors and using the modified seismic training data and the probability map, a plurality of graphs. The distinct set of sensor values can include a simulated distance for each sensor value of the set of sensor values between a simulated location of the sensor values and the simulated seismic event, and introducing, by the one or more processors, a time offset to each arrival time value of the second set of training data and the third set of training data includes introducing, by the one or more processors, a time offset which depends on the simulated distance. the method can include generating, by the one or more processors, seismic training data includes generating, by the one or more processors and using a travel-time based algorithm and the seismic event data, the second set of training data and the third set of training data, wherein the travel-time based algorithm can be an algorithm selected from a list including Fast Marching Method (FMM) algorithms, wave propagation algorithms, or ray tracing algorithms.

In general, an aspect disclosed herein is a non-transitory, computer readable storage medium storing instructions that, when executed by at least one processor, cause the at least one processor to perform operations, including: generating, by the one or more processors, training data including: a first set of training data representing a simulated event, a second set of training data, and a third set of training data, wherein the second set of training data and the third set of training data each represent a distinct set of sensor values corresponding to distinct simulated observation systems, and each distinct sensor value of the second set of training data and the third set of training data includes an associated measurement value; introducing, by the one or more processors, a variation value to each measurement value of the second set of training data and the third set of training data to generate a first set of modified training data and a second set of modified training data; generating, by the one or more processors and using the first set of modified training data and a second set of modified training data, a plurality of graphs, each graph of the plurality of graphs based on at least one of the first set of training data, the first set of modified training data, or the second set of modified training data; and training, using the plurality of graphs as input, the neural network such that the trained neural network generates a variation value correction for each measurement value of the first set of modified training data and the second set of modified training data.

The distinct simulated observation system can include a distributed temperature sensing (DTS) system, an electromagnetic observation system, a medical imaging system, a wireless communications system, or an optical observation system. The time offset generation function can be a time offset correlation function which represents a correlation between at least two variables of the second set of training data, the third set of training data, or both. The network of distributed receivers can include a distributed fiber optic (DFOS) system, a seismograph array, or both.

Particular implementations of the subject matter described in this specification can be implemented so as to realize one or more of the following technical advantages.

The systems and methods described herein correct received seismic arrival time data which reduces error present in the seismic data. Correcting the arrival time data increases the temporal and geospatial accuracy of systems using the corrected data to determine the presence and location of a seismic event. Training machine learning models to perform this correction facilitates decreased times to determination which increases the speed of detection systems described herein. The training data can be data simulated using one or more seismic models representing different detection modes. Simulating the training data increases the speed at which the machine learning models are trained thus decreasing the need to generate live data to train the models. The systems and methods described herein reduce false positive identification and detection of seismic events. The systems and methods achieve this benefit by improving a system’s ability to distinguish signal from noise.

The systems and methods described herein can be used to correct general signals to reduce error in the data. These can include, but are not limited to, time-of-flight (ToF) correction, multipath mitigation in wireless and acoustic channels, signal denoising and reconstruction for low-SNR environments, localization algorithms for positioning systems (GPS, indoor navigation), event detection enhancement in distributed sensor networks, or combinations of these.

The details of one or more embodiments are set forth in the accompanying drawings and the description below. Other features and advantages will be apparent from the description and drawings, and from the claims.

### DESCRIPTION OF DRAWINGS

FIG. 1 is a schematic illustration of a ground-based monitoring system.

FIG. 2 is a flowchart diagram illustrating a method of training a neural network.

FIG. 3 is a schematic diagram that shows an example of a computing device and a mobile computing device.

### DETAILED DESCRIPTION

A cross-sector Subsurface Intelligence Platform enables exploration and extraction of geologic resources at an industrially-applicable scale. Coupling high volume, high variety data with fast, cost-efficient, machine learning-powered computational resources provides an integrated solution that scales across exploration, monitoring, and extraction sites and includes diverse use cases, such as subsurface resource exploration, or infrastructure monitoring. The Platform utilizes terabyte-scale aggregated sensing data to train machine learning models which are then capable of accurately predicting interactions in monitored domains and assessing uncertainty with high accuracy thus increasing operational safety and assurance in example domains such as weather forecasting, or large-scale 3D geological modeling. The Subsurface Intelligence Platform facilitates real-time investigation of complex sub-surface environments using multi-modal sensing. The real-time data collection and analysis simplifies responding to immediate business needs in subsurface-exposed sectors (e.g., geologic carbon storage, or resource extraction).

A challenge of seismic monitoring networks is that systems can use multiple receiving modes to receive and categorize signals. One example is a seismic monitoring network that uses both a fiber optic distributed fiber optic sensing (DFOS) system along with an array of one or more seismometers. Maintaining a synchronized time signal between the different modes is important as the detection and categorization of received signals depends on recorded time-of-arrival values at each receiver and time-of-flight values which are calculated therefrom. One way that such networks can synchronize the time signals is using a global positioning system (GPS) signal. However, a DFOS system may not receive such a GPS signal while each seismometer has an individual GPS synchronization. Thus, the DFOS system may not be synchronized with the array of seismometers and the array of seismometers may report different times. This can lead to different reported times between detected events across both the DFOS system and the network of seismometers thus resulting in false positive events. Using a detection system having synchronized time-of-arrival values facilitates identifying, localizing, and detecting smaller events.

In general, the disclosure relates to a machine learning system trained to correct for differences in GPS-synchronized time signal values, and methods of training such a machine learning model. The method trains a graph neural network (GNN) to correct for these differences by generating simulated data representing a subsurface acoustic event, (e.g., a seismic event) and data collected from two or more seismic monitoring systems. The types of subsurface acoustic events represented by the data can be related to different subsurface acoustic sources, such as an earthquake, a leak or rupture in a municipal water distribution network, or a leak in a carbon sequestration site. Examples of the seismic monitoring systems represented by the data include a DFOS system, an array of seismometers, a geophone network, or a combination thereof.

While the events and signals discussed in this disclosure include acoustic events and signals, it is to be understood that this is not limiting. The events and signals detected or types of data generated by the DFOS system herein can include electromagnetic (e.g., imaging, medical imaging, electroencephalogram (EEG), electrocardiogram (ECG), 5G wireless, global positioning system (GPS) signals, optical signals, satellite communications, radar signals, lidar signals, microwave signals, ultraviolet signals), temperature, seismic (e.g., acoustic, vibration, sonar, ultrasound, elastic, visco elastic, surface waves), or combinations of these.

The generated simulated data is used as input to a GNN model to be trained. The GNN generates graphs representing the subsurface acoustic event data, and the seismic monitoring system data. The GNN determines time offsets to correct for noise or error in the arrival time data in the seismic monitoring system data to synchronize the time values in the sensor data. A trained GNN can be used to correct the arrival time values for distributed seismic monitoring systems to increase the localization accuracy and event detection for such systems.

### SMS System

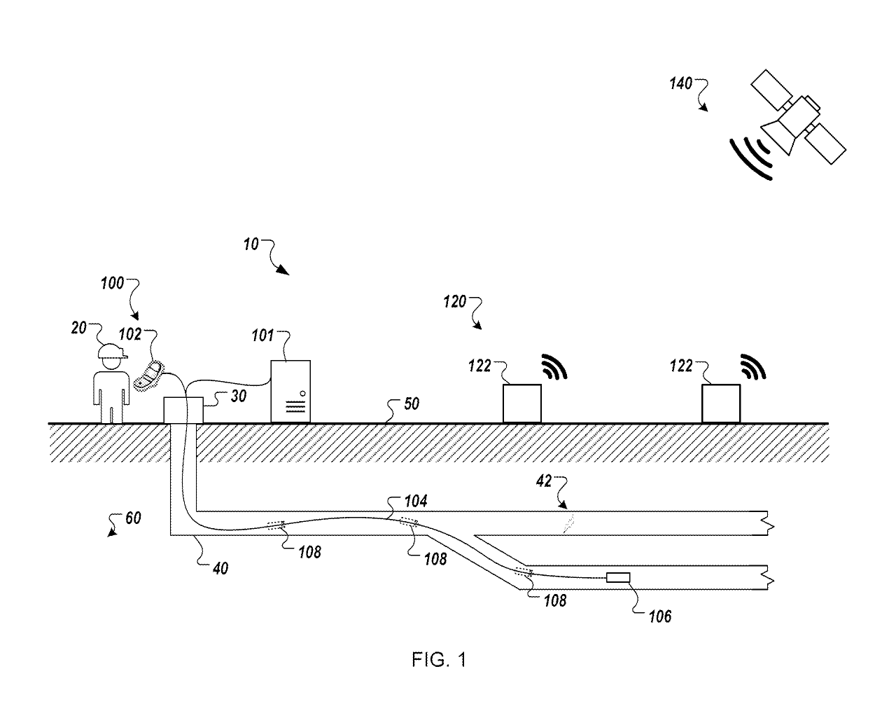

Disclosed herein is a ground-based seismic monitoring system for monitoring subsurface seismic signals, methods for correcting differences in GPS-synchronized time signal values for the SMS, and methods for training a neural network to do the same. An exemplary SMS 10 including a DFOS system 100 and a seismograph array 120 is shown in FIG. 1. The SMS 10 is an example of a seismic monitoring system which uses multiple seismic observation systems to sense acoustic information and monitor an area for seismic events. An example of the DFOS system 100 includes a distributed fiber optic sensing (DFOS) system.

The SMS 10 can be used to identify events beneath the ground surface 50, e.g., within a subterranean formation 60, e.g., within the subsurface network 40 formed in the subterranean formation 60. The SMS 10 includes multiple seismic observation systems for sensing acoustic information. The SMS 10 using multiple seismic observation systems to monitor a geographic region increases event detection geographic accuracy, timing accuracy, and geographic resolution of the SMS 10. The SMS 10 includes a DFOS system 100 and a seismograph array 120. In some examples, the SMS 10 includes further seismic observation systems such as an ocean bottom sensor network, or a geophone/seismometer network.

In some embodiments, the SMS 10 integrates at least one accelerometer sensor with the DFOS system 100 for enhanced capabilities. For example, the SMS 10 detects a range of seismic and acoustic events by merging data from the accelerometer sensor, e.g., an accelerometer found in smartphones, with data from the DFOS system 100. In example implementations, the SMS 10 functions to detect acoustic events using the DFOS system 100 (e.g., the DFOS system) and the seismograph array 120. The SMS 10 is in communication with a global navigation satellite system (GNSS) network 140. One example of a GNSS network 140 is the Global Positioning System (GPS) operated by the United States Space Force. The GNSS network 140 is a satellite-based radio navigation system which can provide geolocation and time information to a GNSS receiver anywhere on or near the Earth.

The SMS 10 connects to the GNSS network 140 through one or more GNSS receiver. The seismograph array 120, the DFOS system 100, or both, include a GNSS receiver to communicate with the GNSS network 140. The SMS 10 receives geolocation information, e.g., location information (e.g., GNSS coordinates, or GPS coordinates), time information, or both, from the GNSS network 140. In some examples, the SMS 10 receives the geolocation information to determine the locations of the seismological sensors of the seismograph array 120, the location of the DFOS system 100. In some examples, the SMS 10 receives the time information to coordinate the time information between the DFOS system 100 and the seismograph array 120. The SMS 10 coordinating time information of the DFOS system 100 and the seismograph array 120 increases the detected time accuracy of detected events.

In example implementations, the SMS 10 is connected to an information network 90, e.g., the internet. The network 90 provides communication to connected servers and computers which can receive and transmit data to the SMS 10. The SMS 10 can process the data received from the DFOS system 100 or the seismograph array 120 using local processors and storage, or communicate the data to the network 90 for processing.

However, error in the time information can be introduced through various sources. Error in the time information can be introduced by errors in internal clocks in each of the DFOS system 100 or the seismograph array 120, errors in calibrating the internal clocks, or errors in receiving time data from an external source. The SMS 10 can include, or be networked to, a machine learning algorithm to correct for the errors in the time information introduced to data collected by the SMS 10.

The SMS 10 detects a seismic signal using one or both of the DFOS system 100 or the seismograph array 120. In some examples, a subsurface seismic event 42 occurs beneath the ground surface 50. The subsurface seismic event 42 generates a subsurface acoustic signal 43 which propagates through the ground surface 50. The seismograph array 120 and the DFOS system 100 detect the subsurface acoustic signal 43.

The DFOS system 100 detects the subsurface acoustic signal 43 as the ground surrounding the fiber optic cable 104 cause vibrations in the fiber optic cable 104. The DFOS system 100 generates a DFOS seismic signal representing the detected subsurface acoustic signal 43. The DFOS system 100 transmits the DFOS seismic signal to a controller of the SMS 10.

The seismograph array 120 detects the subsurface acoustic signal 43 as the subsurface acoustic signal 43 interacts with each of the seismographs 122. The seismograph array 120 generates a seismograph seismic signal representing the detected subsurface acoustic signal 43. The seismograph array 120 transmits the seismograph seismic signal to a controller of the SMS 10.

The SMS 10 determines the spatial position and time at which the subsurface seismic event 42 occurs by coordinating and comparing the signals received from the DFOS system 100 and the seismograph array 120. The subsurface acoustic signal 43 arrives at the point sensors 108 of the DFOS system 100 and the seismographs 122 of the seismograph array 120 at different times based on the distance the subsurface acoustic signal 43 travels and the composition of the ground surface 50. The accuracy of the determined position and time of the subsurface seismic event 42 depends on, but is not limited to, the accuracy of the time signals generated by the GNSS receivers of the DFOS system 100 and the seismograph array 120.

Each of the DFOS system 100 and the seismograph array 120 adds time stamp information to the respective signals. The respective time stamps can be generated from the GNSS receivers associated with the DFOS system 100 or the seismograph array 120. However, differences in the time stamps between the DFOS system 100 and the seismograph array 120 are a source of error in the determination of the position and time of the determined subsurface seismic event 42.

### MLA Module

In example implementations, the SMS 10 includes, or is in communication with, a machine learning algorithm (MLA) module which corrects for errors between the GNSS time stamps between signals received by the SMS 10 from the DFOS system 100 or the seismograph array 120. The MLA module can include a neural network which includes at least one input layer, at least one pooling layer, and at least one global pooling, e.g., output layer.

In some examples, the MLA module includes a graph neural network (GNN). A GNN is an example of a neural network for processing data which can be represented as graphs. In a GNN, the input layer can be a permutation layer which maps a representation of an input graph into an updated representation of the same graph within the GNN.

The SMS 10 receives the DFOS signal from the DFOS system 100 and the seismograph signal from the seismograph array 120. The DFOS signal and the seismograph signal represent information related to the subsurface seismic event 42 and based on the subsurface acoustic signal 43. The DFOS signal and the seismograph signal can include, but is not limited to, arrival time values, signal peak time values, signal peak amplitude values, primary (P) wave amplitude values, P wave envelope values, P wave arrival time values, secondary (S) wave amplitude values, S wave envelope values, S wave arrival time values, probabilities of these values, or combinations thereof.

In example implementations, the SMS 10 provides the DFOS signal and the seismograph signal to the MLA module for time offset correction. The MLA module generates an input graph using the DFOS signal and the seismograph signal. In some embodiments, the input graph represents the spatial distribution of the DFOS system 100 and the seismograph array 120. Each node in the input graph corresponds to a DFOS channel in the DFOS system 100, or and a seismograph in the seismograph array 120. In some examples, the MLA module can generate a probability map which can be used to generate one or more solutions for the time offset correction.

The MLA module applies an algorithm, e.g., Nearest Neighbor Algorithm (NNA), to construct edges of the input graph edges. The MLA module uses the algorithm to connect adjacent DFOS channels and seismographs within the respective DFOS system 100 and the seismograph array 120. Subsequently, the MLA module resamples, e.g., decimates, the DFOS channels to provide resampled DFOS channels. The MLA module connects each resampled DFOS channel to the nearest seismograph sensor in the array 120. This approach balances connectivity between the DFOS system 100 and the seismograph array 120 while optimizing, e.g., reducing, memory usage compared to un-resampled DFOS channels. The MLA module applies the GNN to the input graph and associates seismic parameters with each node or edge, which can be termed node/edge features. The MLA module uses these features to inform its computations during a forward pass to one or more forward layers.

The MLA module receives the DFOS signal and the seismograph signal into an input layer. The MLA module processes the DFOS signal and the seismograph signal through one or more layers to determine the presence of a time offset in the DFOS signal and the seismograph signal. If the MLA module determines that the DFOS signal or the seismograph signal include a time offset error, the MLA module determines a time offset correction for each value in the DFOS signal and the seismograph signal.

The MLA module provides the time offset correction for each value in the DFOS signal and the seismograph signal to the SMS 10. In some examples, the MLA module determines the time offset correction for each value in the DFOS signal and the seismograph signal and applies the time offset correction for each value. In this manner, the MLA module can provide corrected data values to the SMS 10 including event time values of increased accuracy. In some embodiments, the MLA module is trained to look for changes in the time offset corrections over time, e.g., signal drift. The MLA module receives a sequence of time offset corrections corresponding to different signal arrival times and determines the presence of signal drift in the time offset corrections. The MLA module can determine the current drift at the specific time for a length of the DFOS cable, e.g., up to an entire DFOS cable. The MLA module can operate to correct more one or more DFOS cables, e.g., multiple DFOS cables. The MLA module may correct more than one DFOS cables sequentially, or in parallel, e.g., at the same time, or at different times.

The MLA module is trained to determine the time offset between the received DFOS signal values and the received seismograph signal values. Time offsets between the received DFOS signal values and the received seismograph signal values can occur due to differences in the composition of the ground between the seismographs 122 and the subsurface seismic event 42, or between the point sensors 108 and the subsurface seismic event 42. The MLA module is trained to determine the time offset between the received signals and correct for the determined time offset. In some examples, the MLA module is trained to determine the time offset using synthetic data. In general, if the synthetic data includes examples of an offset, signal drift, or both, the MLA module may be trained to determine the time offset if the received values include such examples.

In some examples, the MLA module is trained to determine a repeatable time offset between the DFOS signal and the seismographic signal. A repeatable time offset in the time signals of the DFOS signal and the seismographic signal can indicate, but is not limited to, an error in the time signals for each of the DFOS system 100 or the seismograph array 120. In some examples, each of the seismographs 122 includes a GNSS transceiver and the DFOS system 100 does not include a GNSS transceiver. In such examples, the DFOS time values determined by the DFOS system 100 can include higher error than the seismographic time values determined by the seismograph array 120.

### MLA Module Training

In example implementations, the MLA module can be trained to determine the parameters and corrections described herein using simulated, e.g., computer-generated, training data. In some examples, the simulated training data can be generated based on a simulated seismic event and simulated seismic observation systems. The MLA module receives the simulated training data and processes the simulated training data through the pooling layers. The MLA module updates the parameters for each of the pooling layers to train the pooling layers according to the simulated training data. In some embodiments, the simulated training data includes simulated events generated using travel-time based algorithms, e.g., Fast Marching Method (FMM) algorithms (e.g., Fast Marching Eikonal Methods), wave propagation algorithms, ray tracing algorithms, or combinations of these.

In some embodiments, the simulated data can be generated to include one or more types of noise. The types of noise generated can represent systematic noise (e.g., bias, or drift), measurement error, correlated noise (e.g., dependencies between variables), stochastic noise (e.g., Perlin noise, Gaussian noise, or Poisson noise), or combinations of these. The simulated data can be generated to include realistic noise, such as velocity errors (e.g., local and regional velocity), coupling errors, mispositioning errors, or combinations of these.

In some examples, the types of noise included in the simulated data can be generated to represent, e.g., mimic, a given phenomenon, e.g., simulating types of noise commonly found in seismic data. As an example, noise in arrival times due to local velocity noise may affect many simulated signals.

Some examples of the simulated seismic event include natural earth-based events such as, but not limited to, earthquakes, snowslide, landslide, or other earth movements. Some examples of the simulated seismic event include human-related activities such as, but not limited to, ground transportation (e.g., a subway), ocean transportation (e.g., a boat), mining activities, on-surface or underground exploration activities, resource extraction activities, heavy machinery operation, impact from a falling or sinking object (e.g., anchor drop, boulder or rock fall) or resource storage events (e.g., a leak in an underground resource reservoir, a leak in an underground municipal water distribution network, a leak in a carbon sequestration site, or a water hammer event in an underground municipal water distribution network). Some examples of the simulated seismic event include nature-related events such as, but not limited to, animal noise (e.g., marine mammals, birds, land animal herds).

To determine the parameters and corrections described herein, the MLA module is trained to determine corrections for seismic observation systems of the SMS 10. The seismic observation systems can include the DFOS system 100, the seismograph array 120, and additional systems. Therefore, each seismic observation system included in the SMS 10 can be represented in the MLA module. The individual seismic observation systems are represented in the MLA module according to the data which can be generated by each of the individual systems. For example, the DFOS system 100 is represented by a data set including parameters for the point sensors 108, e.g., time data generated by the DFOS interrogator 101, signal data generated by the DFOS interrogator 101, the positions of the point sensors 108, the position of the sensor package 106, or data which can be received by the sensor package 106, e.g., image parameters, or acoustic parameters.

As another example, the seismograph array 120 data is represented by a data set including parameters for each of the seismographs 122, e.g., the positions of the point sensors 122, simulated GPS or time data generated by the seismographs 122, or seismograph sensor data generated by the seismographs 122, e.g., simulated detected seismic data.

The data representing a simulated seismic event includes parameters described herein which represent the simulated seismic event. Parameters that represent the simulated seismic events can include simulated seismic event time values (e.g., values representing a time at which the event occurred), simulated signal peak amplitude values, simulated primary (P) wave amplitude values, or simulated secondary (S) wave amplitude values, a simulated magnitude, a simulated epicenter location, a simulated focal depth, a simulated fault orientation, a simulated rupture velocity, a simulated slip distribution, a simulated seismic moment, a simulated peak ground acceleration (PGA) value, a simulated peak ground velocity (PGV) value, source mechanism, a simulated peak ground displacement (PGD) value, water leak size, water leak velocity, water leak flow rate, pipe pressure, electrical failure modes, or combinations of these.

The data sets representing the simulated seismic event, the simulated sensor data, or both, can include simulated arrival time values for each of the seismic observation systems, e.g., the point sensors 108 of the DFOS system 100, or the seismographs 122 of the seismograph array 120. The simulated arrival time values can include an associated error in each of the simulated arrival time values. Simulating error in the simulated arrival time values facilitates training the MLA module to correct for errors in arrival time values generated by an in-place SMS 10.

The simulated error in the simulated arrival time values for the DFOS system 100 are independent, e.g., or distinct, or different from, the simulated error in the arrival time values for the seismograph array 120. The simulated error in the arrival time values is independent because the seismographs 122 of the seismograph array 120 may have GNSS transceivers while the DFOS system 100 may not have a GNSS transceiver. A GNSS transceiver generally allows a system to have lower error in their associated time data than a system which does not have a GNSS transceiver.

The MLA module receives at least three data sets representing at least a simulated DFOS signal and a simulated seismograph signal, e.g., to the input layer of the MLA module. The MLA module receives a data set representing a simulated seismic event.

The MLA module processes the data sets representing the received signals and the seismic event, e.g., through the at least one pooling layer. In some examples, the MLA module transforms the data sets from their native data structure into a graph data structure. A graph data structure represents the relationships between parameters as edges (e.g., relationships) between nodes (e.g., the parameters). In some examples, the edges include directional information, e.g., how one parameter (node1) relates to a second parameter (node2).

The pooling layers of the MLA module process the graph data representing the received data sets to determine one or more parameters of the received data sets. In some examples, the parameters include whether a time offset is present in the received signals, whether noise is present in the received signals, or whether a correlation in one or more of the sensed values is present. The pooling layers process the received signals to determine the parameters, remove noise present, or determine the correlation between the sensed values. The SMS 10 receives the processed signals, the parameters, or both, from the output layer of the MLA module. In some examples, the pooling layers of the MLA module can be updated using backpropagation, e.g., in a recurrent or bi-directional graph neural network.

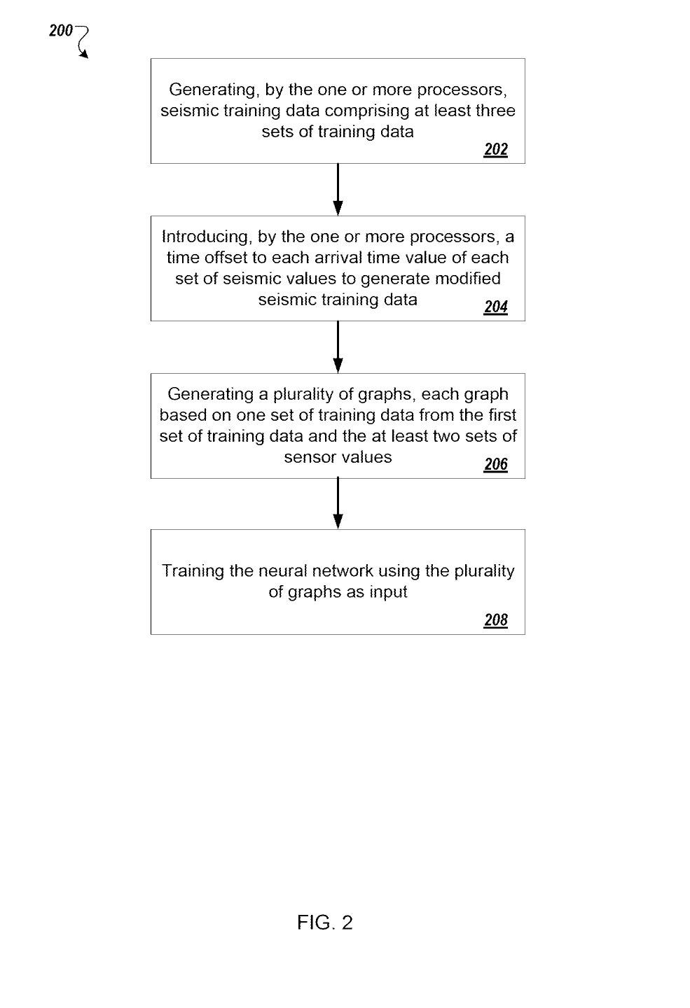

FIG. 2 is a flow chart diagram depicting an example method 200 for training a neural network to determine corrected event time values for one or more seismic observation systems of an SMS. Instructions for causing a computer system to perform the method 200 can be stored on a computer storage medium and executed by one or more processors of the computer system to cause the computer system to perform the following steps.

The computer system generates, by the one or more processors, seismic training data comprising at least three sets of training data (step 202). The seismic training data includes at least a first set representing a simulated seismic event, and at least two sets of sensor values. Each set of sensor values correspond to distinct simulated seismic observation systems, and each seismic value of every set having an associated arrival time value. The simulated seismic observation systems can include a simulated DFOS system, a simulated seismograph array. Optionally, the computer system receives the seismic training data comprising at least three sets of training data from a different computer system.

The computer system introduces a time offset to each arrival time value of each set of seismic values to generate modified seismic training data (step 204). The time offset can be simulated time offset values representing an error in the arrival time value in each received data set. In some examples, the computer system introduces a random time offset to all, or a portion of, the arrival time value of each set of seismic values. The computer system can use a time offset generation function to generate the simulated time offset values for each arrival time of the data set. The time offset generation function can be a random distribution function, a realistic noise function, a systematic function, a measurement error function, a stochastic function, a correlated noise function, or a combination of these.

The computer system generates multiple graphs based on the training data (step 206). Each graph is based on one set of training data from the first set of training data and the at least two sets of sensor values. The computer system can generate any number of graphs based on any number of simulated seismic data and simulated sensor data.

The computer system trains the neural network using the plurality of graphs as input (step 208). Thus, the neural network learns to generate a time value correction for each arrival time value based on the received training data. In some examples, the neural network learns to generate a time value correction for each arrival time value such that the error in time and positioning of test data satisfies an error threshold. The error threshold may include the error in a calculated value satisfying a threshold that is the theoretical limit of the error given the geometry of the problem.

The SMS 10 receives a corrected time offset from the output layer of the MLA module based on the input DFOS signal and the seismograph signal. In some examples, the SMS 10 receives a time-corrected DFOS signal, or a time-corrected seismograph signal from the output layer of the MLA module.

### SMS System Details

Referring again to FIG. 1, additional details of the SMS 10 are described below. The seismograph array 120 is a network of seismological sensors connected by a telecommunications network. The seismograph array 120 monitors the ground surface 50 for subsurface seismic signals. The subsurface acoustic signals can be indicative of one or more subsurface seismic events such as those described herein. The seismograph array 120 detects the subsurface seismic events (e.g., acoustic and/or vibrational disturbances) by sensing vibrations in the ground surface 50 and converting the sensed vibrations into electrical signals. The electrical signals indicating the sensed vibrations can be recorded, stored, or communicated to a device on the network.

The seismograph array 120 includes multiple seismographs 122, though in some examples the seismograph array 120 includes a single seismograph. Each of the seismographs 122 consist of at least a seismometer communicatively coupled with a recording system. Each of the seismographs 122 optionally includes a GNSS transceiver, e.g., a receiver and transmitter.

The SMS 10 includes a DFOS system 100 for monitoring the ground surface 50 for subsurface acoustic signals. The DFOS system 100 is a fiber optic cable-based subsurface seismic event monitoring system. The DFOS system 100 detects subsurface acoustic signals by launching an optical signal into a fiber optic cable 104 and analyzing the returned, e.g., backscattered, optical signal. In some examples, the SMS 10 may include more than one DFOS system. The SMS 10 may aggregate signals from the more than one DFOS system to perform the monitoring of the ground surface 50.

The DFOS system 100 generates the optical signal using a laser source (e.g., which can be mounted in or coupled to the interrogator 101) coupled to glass fibers of the cable 104. The fiber optic cable 104 acts as a long series of sensors arranged at regular intervals. Incident laser light is scattered by deformations, e.g., natural deformations, in the glass fibers. The laser light backscatters and if there is a disturbance, such as a subsurface acoustic signal, the change in the backscatter pattern can be used to sense these subsurface acoustic signals.

Changes in the backscattered light are detected by photodetectors of a DFOS interrogator 101 as an electric output signal. In the DFOS system 100, the electric output signals are processed using hardware or software to provide information on the time and location of the subsurface acoustic signal. The DFOS system 100 is sensitive to both strain and temperature variations of fibers within the fiber optic cable 104 and data can be collected at regular intervals, e.g., sections of the fiber. The subsurface acoustic signal can be indicative of, but not limited to, acoustic vibrations in the surrounding environment (e.g., acoustic waves, seismic waves, ground motion, or earthquakes).

The SMS 10 is in communication with a network 90 to provide or receive data from the network 90. The network 90 can include one or more computing systems hosting computation or analysis modules which receive the data from the user device 102 and return classification data. Examples of the analysis modules which the network 90 can host include trained machine learning models, such as computer vision models employing edge detection networks which receive the image data from the sensor package 106 and return classification data based on one or more detected objects within the image data.

The DFOS system 100 includes a fiber optic cable 104 which extends along the subsurface network 40 beneath the ground surface 50. The subsurface network 40 is a subsurface channel through which the cable 104 extends, such as a shaft, borehole, pipe, or buried in a trench. The DFOS system 100 includes a DFOS interrogator 101 which launches optical signals into glass fibers of a fiber-optic cable 104. The DFOS system 100 also includes a user device 102 which is communicatively coupled to the DFOS interrogator 101 and the fiber optic cable 104 deployed into the SMS 10 through an ingress point 30.

The fiber optic cable 104 is a flexible member that bundles one or more optical fibers into a single fiber optic cable 104. In some examples, the feeding of the cable could be supported by a propulsion or locomotive power device as well (e.g., propeller, pressurized jets/gas, screw propeller, or other device). The length of the fiber optic cable 104 deployed can be controlled by the user 20 handling the spool, or, alternatively, the spool may be mounted into an automatic feeder that regulates the distance and speed at which the fiber optic cable 104 is deployed.

The DFOS system 100 includes a user device 102. The user device 102 provides a user interface for the user 20 to input commands and receive information from the DFOS system 100. Examples of the user device 102 include laptop, tablet, or other computing system which provides a processor, non-volatile storage medium, display device, and input mechanisms for the user 20 to interact with the DFOS system 100.

The DFOS interrogator 101 modulates signal parameters of the optical signal to enable measurements at point sensors 108 (e.g., channels) along the fiber-optic cable 104. The DFOS interrogator 101 can modulate the optical frequency, pulse amplitude, pulse frequency, pulse duration, or duty cycle of the optical signal to enable measurements at, and/or to control the spacing between, the different locations. The DFOS system 100 can generate point sensors 108 at regular intervals having spatial separation that can range, and be adjusted, from the sub-meter scale to 100 meters. The locations of the point sensors 108 along the cable 104 can be determined or changed by the DFOS system 100.

In some examples, the DFOS system 100 may determine the interval in a time dimension, in a spatial dimension, or both. In some examples, the DFOS system 100 may smooth data, e.g., average data, de-noise data, received by the DFOS interrogator 101. The DFOS system 100 may determine whether to smooth the data, and a degree of smoothing the DFOS system may apply to the received data. This may be done with the same parameter for data received along all, or some, of the fiber optic cable 104. In some examples, the DFOS system 101 may smooth the data according to the distance which the signal travelled, e.g., the DFOS system 100 may perform more smoothing over longer distances as the fraction of light that has backscattered increases.

The distance by which the fiber-optic cable 104 is deployed into the subsurface network 40 can depend on the overall length of the fiber-optic cable 104, the maximum distance over which the interrogator 101 is configured to generate point sensors 108, or both. The deployed distance is also the total distance along a single branch of the subsurface network 40 that the DFOS system 100 can map. In some instances, the DFOS system 100 can map up to 200 km of a single branch of the subsurface network 40 (e.g., up to 50 km, up to 100 km, or up to 150 km).

Each optical fiber of the fiber optic cable 104 is a waveguide that can carry respective, different optical signals generated by the DFOS interrogator 101. The DFOS interrogator 101 multiplexes multiple optical signals into the optical fibers, including generating multiple optical signals and transmits all, or some, of the multiple optical signals along a single optical fiber using a DFOS interface on a single fiber and switching between modes. Additionally or alternatively, the optical signals are divided between some or all of the optical fibers of the fiber optic cable 104.

The DFOS interrogator 101 can operate according to one or more DFOS technology standards. DFOS technologies can include receive distributed acoustic sensing (DAS), distributed temperature sensing (DTS), distributed strain sensing (DSS), or combinations thereof. DTS can measure temperature variations along a length (e.g., an entire length, or less than an entire length) of the fiber optic cable, and may use Raman or Brillouin scattering principles. DAS can measure acoustic vibrations or strain changes along a length of the fiber, and may use Rayleigh scattering. DSS can measure mechanical strain along a length of the fiber, and may use Brillouin scattering.

DTS is a key component of the broader DFOS field, offering real-time, continuous temperature monitoring for various applications, such as pipeline leak detection, power cable monitoring, and well integrity assessment.

In some examples, the fiber optic cable 104 is co-located with other types of cable (e.g., power distribution cable) to provide power to and/or data transfer from a sensor package 106 arranged at and connected to an end of the fiber optic cable 104. The sensor package 106 includes one or more sensors for generating data indicative of conditions nearby the sensor package 106. The sensor package 106 can include a camera 110 or a temperature sensor. In some examples, the sensor package 106 includes components which utilize a source of electrical power. In some examples, the DFOS system 100 provides power to the sensor package 106 with a power line carried within the fiber optic cable 104.

In a further example, the DFOS system 100 is used to map the geometry of the subsurface network 40. Generally, subsurface network 40 is a series of interconnected tunnels and turns, each turn producing specific noise patterns in the data collected by the DFOS system 100. During deployment of the fiber-optic cable 104 into the subsurface network 40, the glass fibers within the fiber-optic cable 104 undergo deflections (e.g., shape changes). The deflections cause compression and shear forces on the fibers which causes increased backscatter at the position of the turn. As the fiber-optic cable 104 continues to be deployed in the subsurface network 40, the relative position of the point sensors 108 to the interrogator 101 changes while the absolute position of the turns remains fixed. As such, as each of the point sensors 108 passes the turn, this generates the turn-specific noise pattern at each of the point sensors 108 sequentially.

In another example, the DFOS system 100 is used to perform surface-based geotagging methods (e.g. tap test, active acoustic signal, or other methods). Implementations can include mobile sources which generate directed energy tuned to specific settings (e.g., frequency, amplitude, and/or pattern of waveforms).

In some examples, the camera 110 generates image data along the direction of travel from the sensor package 106. The camera 110 collects image data which the fiber optic cable 104 transmits to the user device 102. The user device 102 may in turn transmit the image data to the network 90 for analysis.

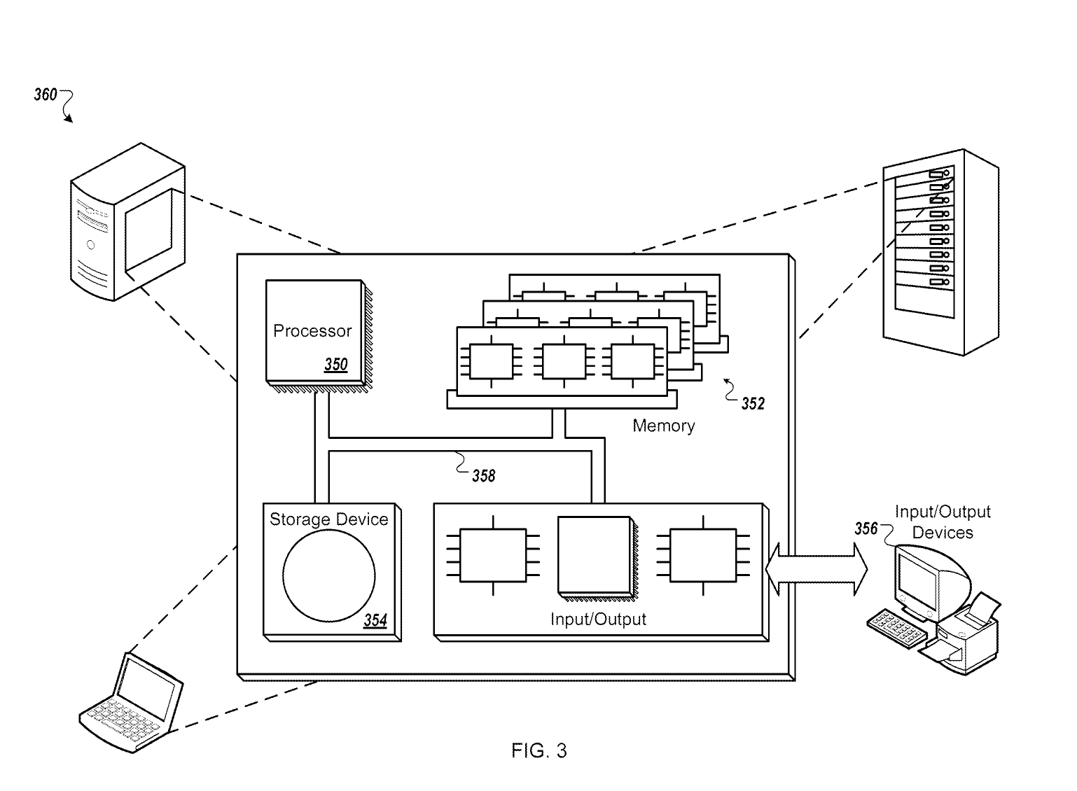

FIG. 3 is a block diagram of an example computer system 300. For example, referring to FIG. 1, the SMS 10, the DFOS system 100, or the seismograph array 120 could include an example of the system 300 described here. The system 300 includes a processor 310, a memory 320, a storage device 330, and one or more input/output interface devices 340. Each of the components 310, 320, 330, and 340 can be interconnected, for example, using a system bus 350.

The processor 310 is capable of processing instructions for execution within the system 300. The term “execution” as used here refers to a technique in which program code causes a processor to carry out one or more processor instructions. The processor 310 is capable of processing instructions stored in the memory 320 or on the storage device 330. The processor 310 may execute operations such as the computer-implemented method of training a neural network described herein.

The memory 320 stores information within the system 300. In some implementations, the memory 320 is a computer-readable medium. In some implementations, the memory 320 is a volatile memory unit. In some implementations, the memory 320 is a non-volatile memory unit.

The storage device 330 is capable of providing mass storage for the system 300. In some implementations, the storage device 330 is a non-transitory computer-readable medium. In various different implementations, the storage device 330 can include, for example, a hard disk device, an optical disk device, a solid-state drive, a flash drive, magnetic tape, or some other large capacity storage device. In some implementations, the storage device 330 may be a cloud storage device, e.g., a logical storage device including one or more physical storage devices distributed on a network and accessed using a network, such as the network 90 shown in FIG. 1.

The input/output interface devices 340 provide input/output operations for the system 300. In some implementations, the input/output interface devices 340 can include one or more of a network interface device, e.g., an Ethernet interface, a serial communication device, e.g., an RS-232 interface, and/or a wireless interface device, e.g., an 802.11 interface, a 3G wireless modem, a 4G wireless modem, etc. A network interface device allows the system 300 to communicate, for example, transmit and receive data such as the seismographic data described herein transmitted or received over the network 90 or GNSS network 140 in FIG. 1. In some implementations, the input/output device can include driver devices configured to receive input data and send output data to other input/output devices, e.g., keyboard, printer and display devices 360. In some implementations, mobile computing devices, mobile communication devices, and other devices can be used.

Referring to FIG. 2, the computer-implemented method of training a neural network can be realized by instructions that upon execution cause one or more processing devices to carry out the processes and functions described above, for example, correcting time information of the received data. Such instructions can include, for example, interpreted instructions such as script instructions, or executable code, or other instructions stored in a computer readable medium.

Although an example processing system has been described in FIG. 3, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

The components of the system can be interconnected by any form or medium of digital data communication, e.g., a communication network such as the 90 shown in FIG. 1. Examples of communication networks include a local area network (“LAN”) and a wide area network (“WAN”), e.g., the Internet.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

What is claimed is:

1. A computer-implemented method of training a neural network, the method executed by one or more processors and comprising:
generating, by the one or more processors, seismic training data comprising: a first set of training data representing a simulated seismic event,
a second set of training data, and
a third set of training data,
wherein the second set of training data and the third set of training data each represent a distinct set of sensor values corresponding to distinct simulated seismic observation systems, and each distinct sensor value of the second set of training data and the third set of training data comprises an associated arrival time value;
introducing, by the one or more processors, a time offset to each arrival time value of the second set of training data and the third set of training data to generate a first set of modified training data and a second set of modified training data;
generating, by the one or more processors and using the first set of modified training data and a second set of modified training data, a plurality of graphs, each graph of the plurality of graphs based on at least one of the first set of training data, the first set of modified training data, or the second set of modified training data; and training, using the plurality of graphs as input, the neural network such that the trained neural network generates a time value correction for each arrival time value of the first set of modified training data and the second set of modified training data.

2. The method of claim 1, comprising generating the time offset using a time offset generation function.

3. The method of claim 1, wherein generating the time offset using the offset generation function comprises generating the time offset for the second set of training data using a first offset generation function and generating the time offset for the third set of training using a second offset generation function that is different than the first offset generation function.

4. The method of claim 2, wherein the time offset generation function is a random time offset generation function.

5. The method of claim 2, wherein the time offset generation function is a time offset correlation function which represents a correlation between at least two variables of the second set of training data, the third set of training data, or both.

6. The method of claim 1, wherein the set of seismic values comprises arrival time values, signal peak time values, signal peak amplitude values, primary (P) wave amplitude values, P wave envelope values, P wave arrival time values, secondary (S) wave amplitude values, S wave envelope values, S wave arrival time values, a simulated magnitude, a simulated epicenter location, a simulated focal depth, a simulated fault orientation, a simulated rupture velocity, a simulated slip distribution, a simulated seismic moment, a simulated peak ground acceleration (PGA) value, a simulated peak ground velocity (PGV) value, source mechanism, a simulated peak ground displacement (PGD) value, a water leak size, or a water leak velocity.

7. The method of claim 1, wherein the distinct seismic collection systems comprise a distributed acoustic sensing (DAS) system, distributed strain sensing (DSS) system, an ocean bottom sensor network, an array of seismometers, a geophone network, an accelerometer network, or a combination thereof.

8. The method of claim 1, wherein the neural network is a graph neural network (GNN).

9. The method of claim 1, wherein the simulated seismic event is an earthquake, a water hammer event in a municipal water distribution network, or a leak event in a carbon sequestration site.

10. The method of claim 1, wherein the simulated seismic event is a nature-related simulated seismic event comprising data representing animal noise.

11. The method of claim 1, comprising generating, by the one or more processors and using the first set of modified seismic training data and the second set of modified seismic training data, a probability map comprising probability values for the time offset for each arrival time value of the second set of training data, the third set of training data, or both, and
generating, by the one or more processors and using the modified seismic training data, a plurality of graphs comprises generating, by the one or more processors and using the modified seismic training data and the probability map, a plurality of graphs.

12. The method of claim 1, wherein the distinct set of sensor values comprises a simulated distance for each sensor value of the set of sensor values between a simulated location of the sensor values and the simulated seismic event, and introducing, by the one or more processors, a time offset to each arrival time value of the second set of training data and the third set of training data comprises introducing, by the one or more processors, a time offset which depends on the simulated distance.

13. The method of claim 1, wherein generating, by the one or more processors, seismic training data comprises generating, by the one or more processors and using a travel-time based algorithm and the first set of training data, the second set of training data and the third set of training data, wherein the travel-time based algorithm is an algorithm selected from a list including Fast Marching Method (FMM) algorithms, wave propagation algorithms, or ray tracing algorithms.

14. A non-transitory, computer readable storage medium storing instructions that, when executed by at least one processor, cause the at least one processor to perform operations, comprising:
generating, by the one or more processors, training data comprising:
a first set of training data representing a simulated event,
a second set of training data, and
a third set of training data,
wherein the second set of training data and the third set of training data each represent a distinct set of sensor values corresponding to distinct simulated observation systems, and each distinct sensor value of the second set of training data and the third set of training data comprises an associated measurement value;
introducing, by the one or more processors, a variation value to each measurement value of the second set of training data and the third set of training data to generate a first set of modified training data and a second set of modified training data;
generating, by the one or more processors and using the first set of modified training data and a second set of modified training data, a plurality of graphs, each graph of the plurality of graphs based on at least one of the first set of training data, the first set of modified training data, or the second set of modified training data; and training, using the plurality of graphs as input, a neural network such that the trained neural network generates a variation value correction for each measurement value of the first set of modified training data and the second set of modified training data.

15. The computer readable storage medium of claim 14, wherein the distinct simulated observation systems comprise a distributed temperature sensing (DTS) system, an electromagnetic observation system, a medical imaging system, a wireless communications system, or an optical observation system.

16. The computer readable storage medium of claim 14, comprising generating the variation value using a variation value generation function and the variation value generation function is a variation value correlation function which represents a correlation between at least two variables of the second set of training data, the third set of training data, or both.

17. A system for monitoring seismic events, comprising:
a network of distributed receivers; and
a seismic monitoring system that comprises one or more processors configured to perform operations comprising:
generating, by the one or more processors, seismic training data comprising:
a first set of training data representing a simulated seismic event,
a second set of training data, and
a third set of training data,
wherein the second set of training data and the third set of training data each represent a distinct set of sensor values corresponding to distinct simulated seismic observation systems, and each distinct sensor value of the second set of training data and the third set of training data comprises an associated arrival time value;
introducing, by the one or more processors, a time offset to each arrival time value of the second set of training data and the third set of training data to generate a first set of modified training data and a second set of modified training data; generating, by the one or more processors and using the first set of modified training data and a second set of modified training data, a plurality of graphs, each graph of the plurality of graphs based on at least one of the first set of training data, the first set of modified training data, or the second set of modified training data; and
training, using the plurality of graphs as input, a neural network such that the trained neural network generates a time value correction for each arrival time value of the first set of modified training data and the second set of modified training data.

18. The system of claim 17, wherein the network of distributed receivers includes a distributed fiber optic (DFOS) system, a seismograph array, or both.
